(19) United States
(12) Patent Application Publication
(10) Pub. No.: US 2007/0260515 A1
(43) Pub. Date: Nov. 8, 2007

(54) Method and system for pacing online advertisement deliveries

(76) Inventors: Michael A. Schoen, Tiburon, CA (US); Michael L. Grubb, San Francisco, CA (US); Martin L. Price, Daly City, CA (US)

Correspondence Address: GREENBERG TRAURIG, LLP (SV2), 2450 Colorado Avenue, Suite 400E, Santa Monica, CA, 90404, US

(21) Appl. No.: 11/429,329

(22) Filed: May 5, 2006

(51) Int. Cl. G06Q 30/00

(52) U.S. Cl. 705/14

(57) ABSTRACT

A method and system for pacing online advertisement deliveries are disclosed. According to one aspect of the invention, the present invention overcomes the problems in the existing art described above by providing a method and system for pacing the delivery of online advertisements. In one embodiment, a method, that is to be implemented on a system, is provided to identify a rate at which billable events for an online advertisement occur; and adjust at least one of a pace the online advertisement is served, or an amount charged for the advertisement being selected, based on the rate the online advertisement is selected and a budget limit.

### TECHNICAL FIELD

One embodiment relates generally to online advertisement delivery services. In particular, one embodiment relates to a method and system for pacing online advertisement deliveries.

### BACKGROUND

Advertisers have discovered that the Internet, and the World Wide Web in particular, provides an excellent platform for reaching potential customers. To serve advertisers' needs, companies devoted to serving online advertisements have developed methods and techniques allowing advertisers to carefully target the proper audience with their advertisements. For example, Internet advertisement service providers operate ad servers that enable advertisers to target specific audiences by matching advertisements with keyword searches and/or the content of web pages.

A conventional ad server serves advertisements when certain predefined events occur. The ad server may, for example, serve a particular advertisement when one or more keywords associated with the particular advertisement are present in the content (e.g., text, images, meta-data) of a web page requested by an end-user. Alternatively, the ad server may serve a particular advertisement when one or more keywords associated with the advertisement are entered, or input, in a search executed by an end-user. In either case, the ad server may recognize that the predefined event has occurred and serve the particular advertisement to the end-user.

The advertiser, whose advertisement has been served, may be charged a fixed amount each time the advertisement is served, or each time a served ad is selected (e.g., clicked) by an end-user. Advertisement services based on the latter fee structure are often referred to as pay-per click (PPC) systems. In either case, the advertiser generally deposits funds in an account held with the advertisement service provider, and the account is debited a predetermined amount each time a billing event occurs, such as: when an advertisement is served; each time an advertisement is selected (e.g., clicked); each time an advertisement is served and a sales call or direct contact between the advertiser and the end-user ensues; or each time an advertisement is served and a sale, membership, inquiry, enrollment, pledge, or other predefined responsive action by the end-user occurs.

One of the problems encountered when setting up an account with an advertisement delivery service is determining a proper budget. Predicting the frequency with which a particular predefined event might occur over a given amount of time is difficult. For example, it is difficult for an advertiser to predict with accuracy the number of times in a given day an end-user will execute a search with a particular keyword or keywords. Similarly, it is difficult for an advertiser to predict with accuracy the number of times end-users will request web pages having content containing particular keywords. Consequently, if an advertiser's budget for a particular advertisement is too small, the advertisement may be served and/or selected several times in a very short period of time. On the other hand, if an advertiser's budget is too large, the advertiser's advertisement may be served too frequently.

### SUMMARY OF THE DESCRIPTION

One embodiment overcomes the problems in the existing art described above by providing a method and system for pacing the delivery of online advertisements. In one embodiment, a method, that is to be implemented on a system, is provided to identify a rate an online advertisement is selected by end-users; and adjust at least one of a pace the online advertisement is served, or an amount charged for the advertisement being selected, based on the rate the online advertisement is selected and a budget limit.

Adjusting the pace advertisements are served includes decreasing the pace the advertisements are served. Decreasing the pace the advertisements are served is to prevent charges for the advertisement, within a budget period, from exceeding the budget limit. Alternatively, adjusting the rate the advertisement is served includes increasing the rate at which the advertisement is served.

In one embodiment, adjusting the pace is further based on at least one of a time period within a budget period, and/or a rate the advertisement was selected in a prior budget period.

In one embodiment, adjusting the pace includes periodically omitting (in a random or predetermined sequence) serving the advertisements when the advertisements are to be served. Alternatively, adjusting the pace includes adjusting a matching criteria for the advertisement. Adjusting the matching criteria includes one of expanding or contracting the matching criteria for the advertisement. Alternatively, adjusting the pace includes adjusting a priority of the advertisement relative to other advertisements.

In one embodiment, identifying the rate of an online advertisement's billing events and adjusting the pacing, are performed randomly during a budget period. Alternatively, the identifying and the adjusting are performed at pre-set time periods during a budget period. In one embodiment, the identifying and the adjusting are performed at time periods based on at least one of a time period remaining in a budget period, an amount remaining within budget limit, and/or a rate of billing events for the advertisement is selected within at least one of a current budget period or a prior budget period.

In one embodiment, in response to reaching a budget limit for an advertisement, serving the advertisement is ceased, or charging for the advertisement when the advertisement is selected by an end-user or another billing event occurs, is ceased.

### BRIEF DESCRIPTION OF THE DRAWINGS

Embodiments are illustrated by way of example and not by way of limitation in the figures of the accompanying drawings in which like references indicate similar elements, and in which:

FIG. 1 illustrates a network environment in which an embodiment may be implemented;

FIG. 2 illustrates an example of a web page with a targeted advertisement served from an ad server, according to an embodiment;

FIG. 3 illustrates a logical block diagram of an ad server, according to an embodiment;

FIG. 4 illustrates an advertisement pacing module, including inputs and outputs, according to an embodiment;

FIG. 5 illustrates an example of the advertisement delivery distribution over time with an advertisement pacing module 31, according to an embodiment;

FIG. 6 illustrates a method 60, according to an embodiment, for pacing the delivery of advertisements;

FIG. 7 illustrates an example of a computing system, with which embodiments might be implemented.

### DETAILED DESCRIPTION

The following provides a detailed description of a method and system for pacing the delivery of online advertisements. In the following description, for purposes of explanation, numerous specific details are set forth in order to provide a thorough understanding of different embodiments. It will be evident to one skilled in the art, however, that the present invention may be practiced without these specific details. The description and representation herein are the means used by those experienced or skilled in the art to effectively convey the substance of their work to others skilled in the art. In some instances, to avoid unnecessarily obscuring tangential aspects of the present invention, well-known operations and components have not been described in detail.

Reference herein to “one embodiment” or “an embodiment” means that a particular feature, structure, operation, or other characteristic described in connection with the embodiment may be included in at least one implementation of the invention. However, the appearance of the phrase “in one embodiment” or “in an embodiment” in various places in the specification does not necessarily refer to the same embodiment.

Overview of Online Advertisement Pacing

In one embodiment of the present invention, an ad server serves advertisements (also known as “impressions”) when certain predefined events occur. For example, the ad server may serve a particular advertisement when one or more keywords associated with the particular advertisement are present in the content of a web page requested by an end-user. Alternatively, the ad server may serve a particular advertisement when one or more keywords associated with the advertisement are entered, or input, in a search executed by an end-user. In either case, the ad server may recognize that the predefined event has occurred and serve the particular advertisement in response.

In one embodiment of the invention, the ad server includes an advertisement pacing module that monitors the frequency of an advertisement's billing events in view of a predetermined budget for the advertiser or advertisement, and adjusts the pace at which advertisements are served to achieve an advertiser objective. Billing events are predetermined events when an advertiser is charged and may include such events as: when an advertisement is displayed to an end-user; when an advertisement is selected by an end-user; when an advertisement is displayed to an end-user and a sales call or other direct contact between the advertiser and end-user results; or, when an advertisement is displayed to an end-user and a sale, membership, inquiry, enrollment, pledge, or other predefined responsive action by the end-user occurs. Alternatively, the amount charged to the advertiser, and/or whether the advertiser is charged at all, in response to an advertisement being selected by an end-user, is adjusted. In one embodiment, the adjustment(s) are made to help an advertiser stay within a pre-set budget.

Online Advertisement Process

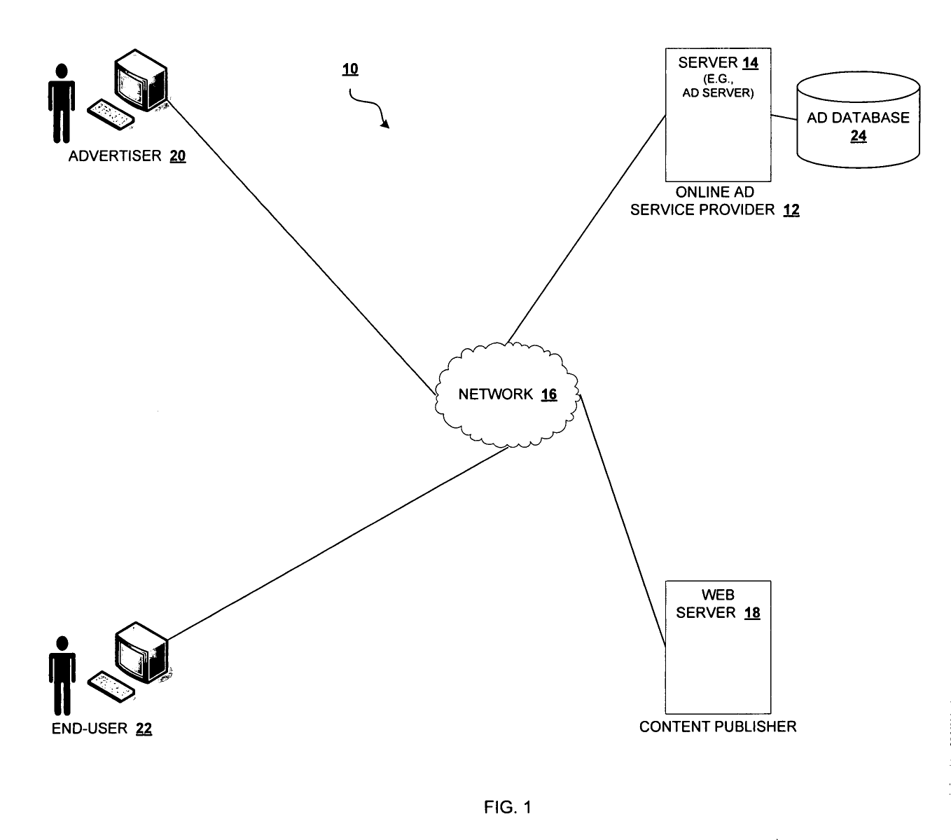

FIG. 1 illustrates a network environment 10, in which an online ad server 14, according to an embodiment of the invention, may operate. As illustrated in FIG. 1, the online advertisement service provider 12 operates a server 14 (e.g., ad server) that is connected by means of a network 16 (e.g., such as the Internet) to a web server 18 of at least one content publisher 20. In addition, both the ad server 14 and the publisher's web server 18 are accessible to advertisers and end-users via client computers (e.g., advertiser client 20 and end-user client 22.)

Generally, the ad server 14 provides a number of services to assist an advertiser in generating an advertisement, and targeting an audience for the advertisement. For example, after establishing an account with the online advertisement service provider 12, the advertiser may generate one or more advertisements. In one embodiment of the invention, the ad server 14 may facilitate the generation of the advertisement with online editing tools. In any case, after the advertisement has been generated, the advertiser associates the advertisement with one or more keywords. In one embodiment of the invention, the advertiser bids against other advertisers for the keywords in an electronic auction, facilitated by the ad server 14. Assuming the advertiser bids a sufficient amount, the advertiser wins the right to have the keywords associated with his or her advertisement.

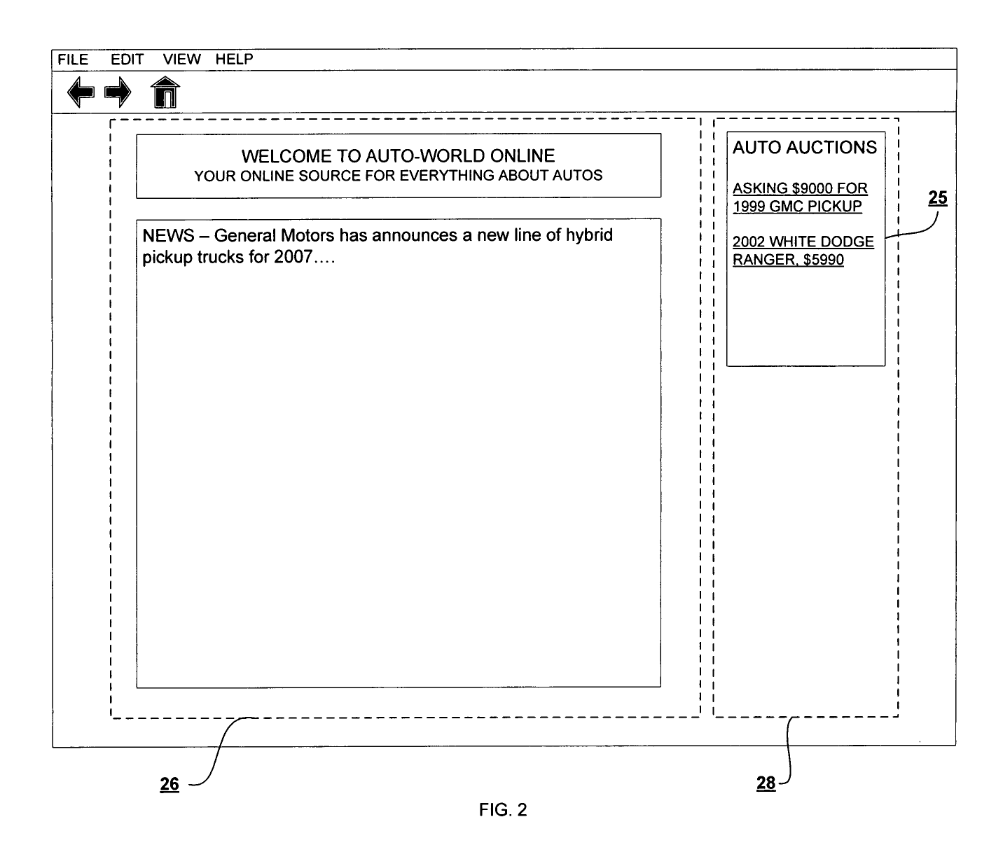

FIG. 2 illustrates an example of a web page 25 with a targeted advertisement 27 served from an ad server 14, according to one embodiment. For example, an automobile dealer may generate an advertisement 27 listing autos for sale, and then associate the advertisement 27 with the keyword, “autos” and/or “pickup.” Accordingly, the ad server 14 may serve that particular advertisement 27 when the content of a publisher's web page 25 includes the keyword(s) associated with the advertisement. If, for example, an end-user 22 requests a web page from the content publisher's web server 18, and the web page includes content related to autos, the ad server 14 may place or serve the advertisement alongside the content related to autos. In FIG. 2, for example, the web page 25 includes a content portion 26, served from the content publisher's web server 18, and an advertisement portion 28, served from the ad server 14. Typically, the ad server 14 will select the particular advertisement to serve based, in part, on the textual content of the content portion 26 of the web page 24. (The textual content may include both the visual portion, as well as any meta-data that is not visible to the end-user.) Alternatively, the ad server 14 may select the particular advertisement to serve based on a keyword search performed by the end-user.

An ad, such as that illustrated in FIG. 2, may consist of text, a graphical image or set of graphical images, audio, video, video with audio, or any other digital representation of the advertiser's message, including a hyperlink to the same. For example, in one embodiment of the invention, an advertisement is coded using conventional coding techniques and languages, such as hypertext markup language or HTML.

Ad Server

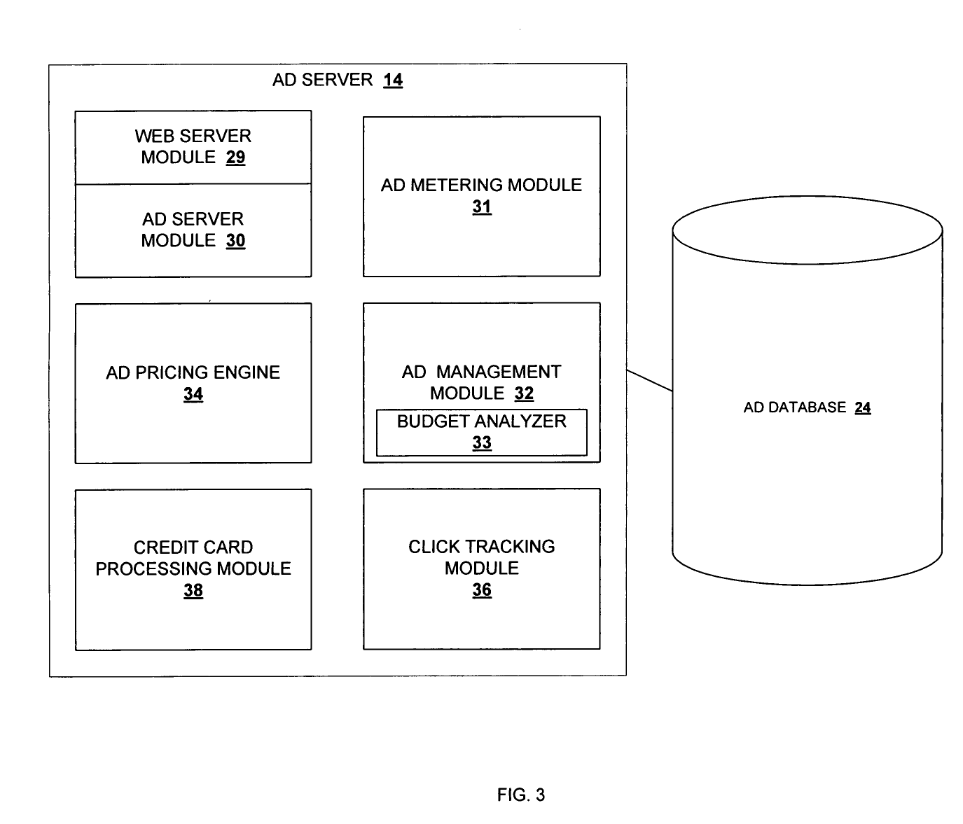

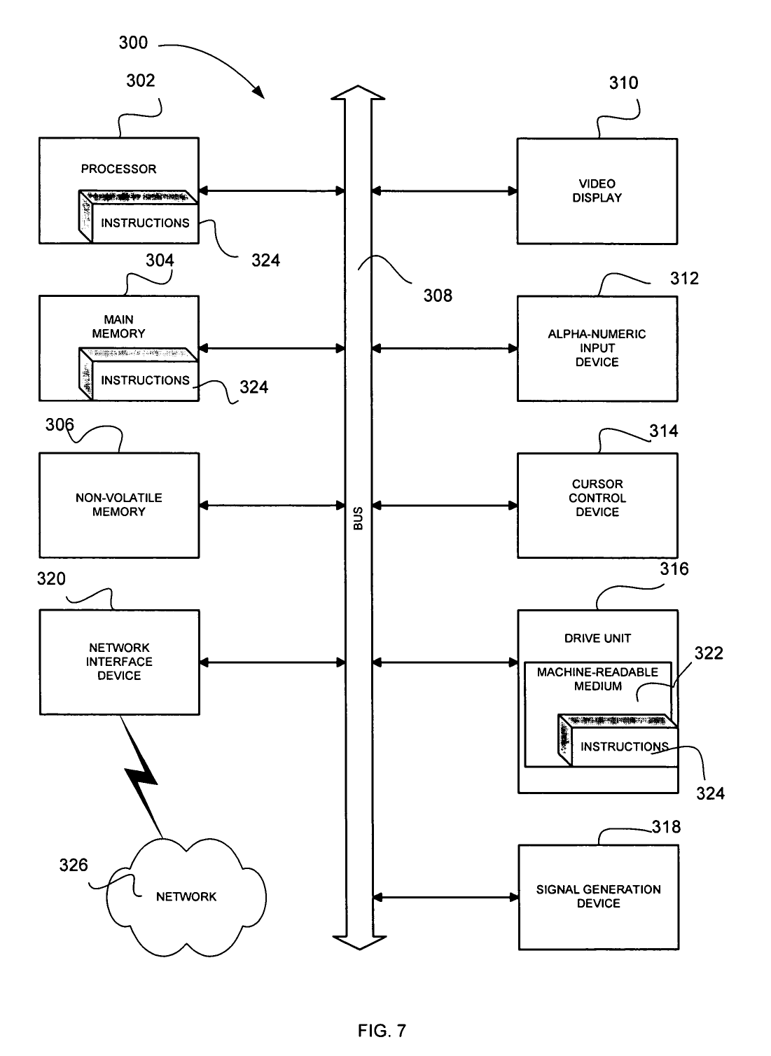

FIG. 3 illustrates a logical block diagram of an ad server 14, according to one embodiment. An ad server 14 includes one or more of, a web server component 29, an ad server module 30, an advertisement pacing module 31, an advertisement management module 32, an advertisement pricing engine 34, a click tracking module 36, and a credit card processing module 38. It will be appreciated by those skilled in the art that the various functional modules presented in FIG. 3 may be implemented in software, hardware, or a combination thereof. For example, a computer system such as that illustrated in FIG. 7 may be utilized to implement the particular functional blocks shown in FIG. 3. Furthermore, the particular functions provided by each module in FIG. 3 may be combined with other logical modules (not shown), which provide services that are tangential to those of the present invention.

In one embodiment, the ad server module 30 facilitates the serving of advertisements. For instance, when an end-user, utilizing a conventional web browser application, requests and receives an Internet document (e.g., web page), that document may include code that directs the web browser to request an advertisement from the ad server 14. Consequently, the ad server module 30 may receive and process the request. For example, the ad server module 30 may identify the particular advertisement that is to be served, read the particular advertisement from storage (e.g., advertisement database 24), and then serve the advertisement to the requesting browser application 22. Accordingly, in one embodiment, the ad server 14 is tightly integrated with the web server component 29. In an alternative embodiment, the ad server module 30 may function much the same way that a conventional web server functions. Moreover, in one embodiment, the ad server module 30 may be, or may include, a conventional web server component for serving advertisements.

The ad server 14 also includes an advertisement management module 32. In one embodiment, the advertisement management module 32 facilitates the generation and management of advertisements. For example, the advertisement management module 32 may include a user interface component, served by the web server component 29 that facilitates generating and/or modifying advertisements. In one embodiment of the invention, the advertisement management module 32 may also facilitate other administrative tasks associated with managing and configuring the advertisements. For example, via the advertisement management module 32, advertisers may be able to schedule times (e.g., days, weeks, months) when their advertisements are to be served to end-users.

In one embodiment, the advertisement management module 32 facilitates the linking of advertisements to particular keywords. For example, after an advertiser has generated an ad, the advertiser may utilize the advertisement management module 32 to link or associate the advertisement with one or more keywords. Consequently, the ad server 14 utilizes the keyword association to determine when the advertisement should be served. For example, the advertisement may be served when an end-user performs a keyword search that matches one or more keywords associated with the ad. Alternatively, the advertisement may be served when an end-user requests a web page that includes content (e.g., text) that matches one or more keywords. In the case of a keyword search, the actual keywords entered by the user may be forwarded from the web server handling the actual search (e.g., the publisher's web server 18) to the ad server 14. In the case of matching a web page's content, the ad server 14 may include a web crawler or other automated background application that analyzes the content of several web pages, and stores the analysis in a database.

In one embodiment, the advertisement management module 32 includes a budget analyzer 33. The budget analyzer 33 analyzes budgets limits established by advertisers, and prevents advertisements from being served when a particular advertiser has reached its established budget limit. In one embodiment, the budget limit is based on daily expenditures. In alternative embodiments, the budget limit is based on one of one or more hours, multiple days, a week, multiple weeks, etc.

In one embodiment of the invention, the budget analyzer 33 prevent advertisements from being served before the actual budget limit has been reached. For example, in the case when one more clicked advertisement will result in a debit that exceeds the budget limit, the budget analyzer 33 prevents an advertisement from being served. Alternatively, the budget analyzer prevents a charged from being assessed to the advertiser, in response to the advertisement being selected.

In addition, the budget analyzer 33 analyzes the balance for each advertiser's account in order to keep sufficient funds available to serve advertisements. For example, in one embodiment, when an advertiser's account reaches a predetermined minimum level (e.g., such as three times the established daily budget), the budget analyzer 33 causes the advertiser's credit card to be charged. In one embodiment, when the predetermined minimum level is reached, the budget analyzer charges the advertiser's credit card an amount equivalent to the billing increment. In one embodiment, the amount charged is equal to the amount originally deposited by the advertiser when initially established the account.

The ad server 14, according to one embodiment, also includes a credit card processing module 38. Accordingly, the credit card processing module 38 provides an interface to a third-party credit card processor, who handles transactions on behalf of the online advertisement service provider.

In one embodiment, the ad server 14 includes a click tracking module 36. The click tracking module 36 monitors when an advertisement is clicked (i.e., selected by an end user). Accordingly, when the click tracking module 36 detects a click, the advertiser's account associated with the selected advertisement, is debited a predetermined amount.

In one embodiment, the amount debited per click is determined based on the cost of the keywords. As the keywords are auctioned off, the popularity or demand for the keywords play a role in establishing the price of the cost per click for each advertisement. For example, in one embodiment, the advertisement pricing engine 34 includes logic to facilitate electronic auctions for one or more keyword(s). Accordingly, as more participants bid on a particular keyword, the price for that keyword increases.

Advertisement Pacing

In one embodiment, the ad server 14 includes an advertisement pacing module 31. The advertisement pacing module 31 measures or monitors the frequency/rate of the billable events of an advertiser's advertisement(s), and adjusts the rate/pace at which advertisement(s) are served, or an amount an advertiser is charged, to have the advertiser stay within a pre-set budget.

For example, the pacing module, in communication with the click tracking module, determines the frequency/rate that an advertiser's advertisements are selected or that other billable events have occurred, (i.e., how many times has the advertiser been charged within a specific period of time). The pacing module, in communication with the budget analyzer module, determines whether at the current pace the advertiser is being charged, the advertiser is likely to meet or exceed their respective budget limit for a budget period.

If the advertiser is likely to exceed their respective budget limit, the pacing module will decrease a pace of serving the advertiser's advertisement(s). In one embodiment, to decrease the pace of serving the advertiser's advertisement(s), the pacing module selects a frequency to omit serving the advertisement (e.g., once every four times the advertisement is to be served). In one embodiment, the omission of serving the advertisement is conducted randomly within a particular number of opportunities to serve the advertisement, or randomly based on a time consideration. Alternatively, the omission is conducted in a predetermined sequence (e.g., once every four times the advertisement is to be served).

In one embodiment, the rate at which an advertisement is served can be increased or decreased by making adjustments to a priority level for a particular advertisement, relative to related advertisements, for a designated period. Priority levels can be adjusted by imputing a higher click-through rate to the ad than it has actually accumulated. Use this higher click-through rate in the yield ranking calculation where the rank of the result is determined in part by the maximum bid and the click-through rate associated with the ad. This will have the effect of causing the ad to be ranked higher than otherwise and to be displayed more frequently, as a result.

In addition, adjustments to whether an advertisement(s) is to be served, can be made via adjustments to the matching criteria associated with an advertisement(s). The matching criteria can be expanded or contracted. The advertisement(s) can be associated with more key words or subjects resulting in increased serving of the advertisement(s), or associated with less key words or subjects, resulting in a decrease of serving the advertisement(s).

In one embodiment, the pacing module will decrease an amount charged to the advertiser for the advertisements being selected or other billable events, including assessing no charge. Alternatively, the pacing module will do a combination of decreasing a pace of serving the advertisements and decreasing an amount charged to the advertiser.

The frequency of the pacing module determining whether adjustments to the pacing of advertisements delivery, or pricing, are needed, is performed intermittently based on predetermined time periods, or is performed randomly. In one embodiment, the time periods vary based on one or more factors, including, but not limited to, the time remaining for a budget period, volatility in the frequency the advertisement is selected by end-users, and an amount remaining within the budget for the budget period.

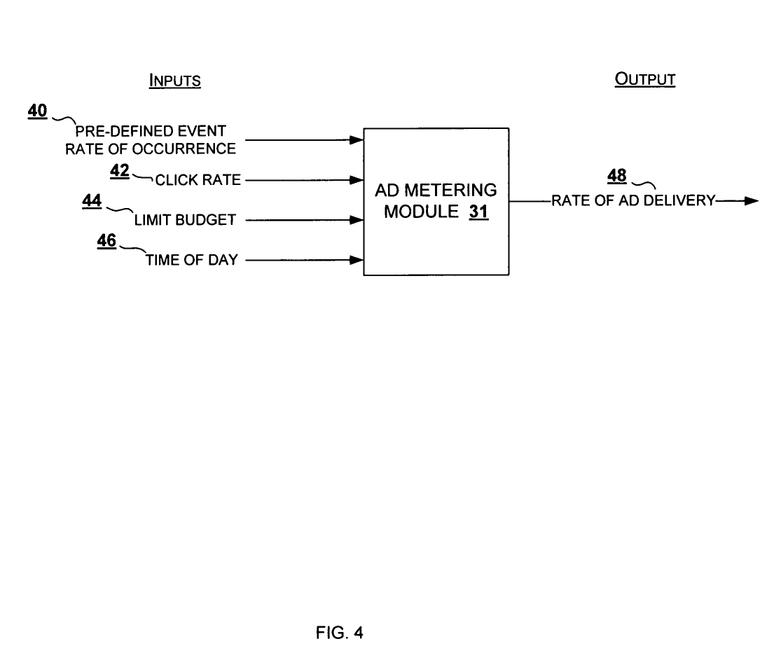

FIG. 4 illustrates an advertisement pacing module, including inputs and outputs, according to one embodiment. As illustrated in FIG. 4, the advertisement pacing module 31 receives as inputs the click rate 42 for an advertisement(s), the budget limit 44 for all clicks associated with that advertisement(s) for a budget period, and the time of day 46 or the time remaining for the present budget period. The metering module also includes as an input, in one embodiment; a pre-defined event rate of occurrence 40 (e.g., rate of serving the advertisement.

In an alternative embodiment, the pacing module further includes past performance of click rates for an advertisement(s). For example, the past performance may identify previous click rates for an advertisement(s) for previous budget periods, including previous click rates of the time periods that remain in the current budget period.

The output for the advertisement pacing module 31 is the rate of advertisement delivery 48 for a particular ad. Accordingly, the advertisement pacing module 31, in one embodiment of the invention, determines the rate at which advertisements are served or delivered.

The click rate 42 is an input to the advertisement pacing module 31 that represents the rate at which a particular advertisement is selected in one embodiment. For example, if an advertisement is served one hundred times, and selected fifty of those one hundred, then the click rate is fifty percent. Alternatively, the click rate represents how often an advertisement is selected by an end-user, within a period of time (i.e., a period of time for which a budget limit has been set for an advertiser's advertisement(s)).

The daily budget input 44 represents an amount of funds that the advertiser has selected as the maximum amount to be debited from an account in connection with billable events for a particular ad. For example, the daily budget serves as an upper limit. In one embodiment of the invention, advertisements are not served once the daily budget has been reached.

An additional input for the advertisement pacing module 31 is the time of day 46, or the time remaining within the budget period. Accordingly, the advertisement pacing module 31 utilizes the time of day to adjust the rate at which advertisements are served. In one embodiment, the advertisement pacing module increases the rate at which a particular advertisement is served based on time preferences selected by an advertiser. For example, the rate at which an advertisement related to fast food meals is served may be designated to increase around traditional meals times, such as noon.

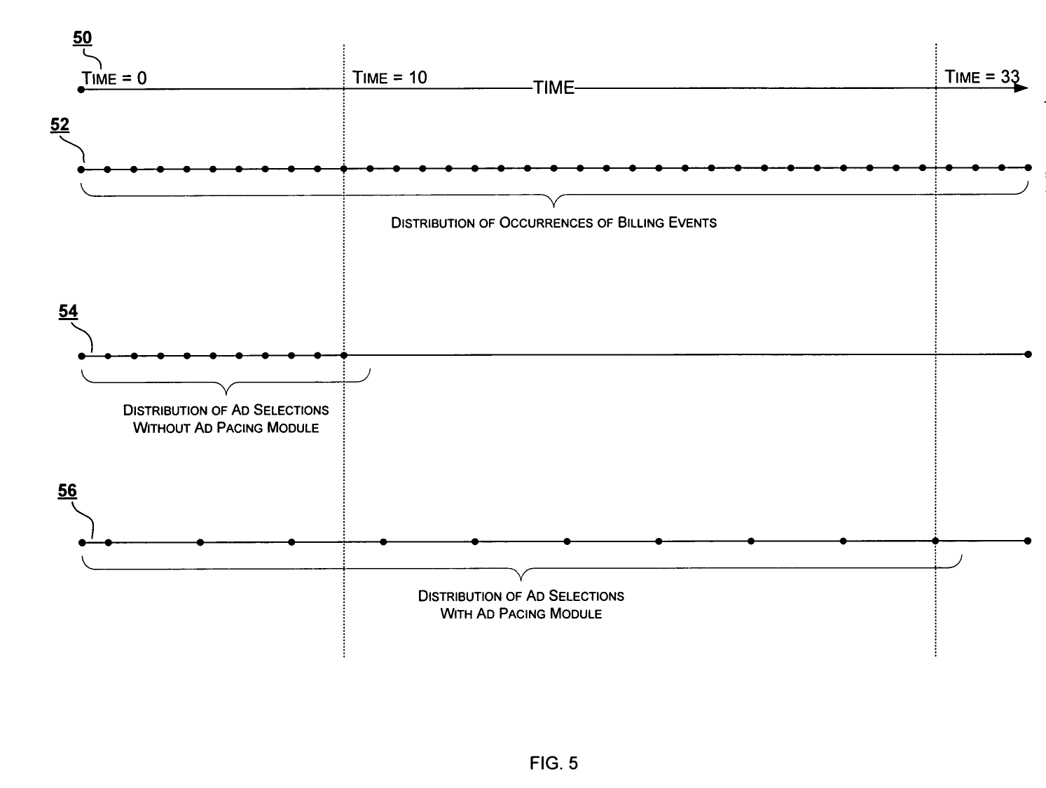

FIG. 5 illustrates an example of the advertisement delivery distribution over time with an advertisement pacing module 31. Line 50 represents time, or more specifically, the passing of time moving from left to right. Accordingly, the dots shown on line 52 represent billing events for an advertisement(s) (i.e., an advertisement(s) has been selected by an end-user).

Line 54 represents the distribution of advertisement selections without an advertisement pacing module, while the line 56 represents the distribution of advertisement selections with an advertisement pacing module. As illustrated in FIG. 5, without an advertisement pacing module, advertisements are delivered at every opportunity, and consequently, ten advertisements are delivered consecutively after the passing of ten units of time (represented on line 50 as “time=10”). If, for example, the advertiser has established a twenty dollar daily budget, and the cost per click for the particular advertisement is two dollars, at time equal to 10 the advertiser has reached his budget limit.

However, with an advertisement pacing module 31, the distribution of selected advertisements is more evenly distributed over the time period. This allows the advertiser to reach his budget limit over a given period of time, while ensuring that advertisements are served over the entire period of time, not just in one short segment.

In the example illustrated in FIG. 5, the advertisement pacing module 31 is being utilized to reach but not exceed the advertiser's budget limit. However, it will be appreciated by those skilled in the art, that the advertisement pacing module may be utilized to achieve other objectives as well. For example, the advertisement pacing module 31 may be utilized to ensure that an advertiser's advertisements are served only during a specific-interval of time.

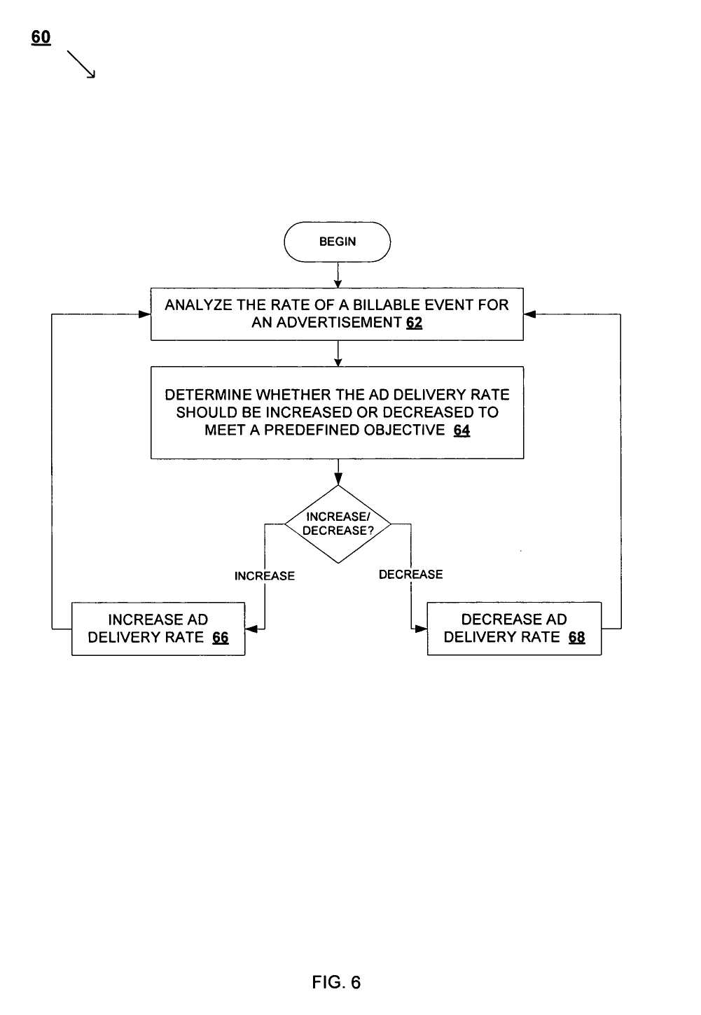

FIG. 6 illustrates a method 60, according to one embodiment, for pacing the delivery of advertisement(s). In FIG. 6, at operation 60, the rate advertisement(s) are selected by end-users is analyzed. For example, the advertisement pacing module 31 may receive click rate or other billable event information from the click tracking module 36. Accordingly, the advertisement pacing module periodically or continuously analyzes the rate at advertisement(s)are selected, or clicked, by end-users or other billable events.

At operation 64, the advertisement pacing module determines whether the advertisement delivery rate needs to be increased or decreased to meet a predefined objective. For example, if the objective is to meet, but not exceed, an advertiser's budget limit, then the rate at which advertisements are served may need to be increased (e.g., operation 66) or decreased (e.g., operation 68) to meet the budget limit during the respective budget period. Alternatively, the amount charged for an advertisement being selected, may be adjusted to meet the budget limit.

### CONCLUSIONS

FIG. 7 shows a diagrammatic representation of a machine in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server (e.g., host 12) or a client 14 machine in a client-server network environment, or as a peer machine in a peer-to-peer (or distributed) network environment. The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Furthermore, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a nonvolatile memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media. The software 324 may further be transmitted or received over a network 326 via the network interface device 320.

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and a system for billing for advertisement services have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
identifying a rate of billable events for an online advertisement; and
adjusting at least one of a pace the online advertisement is served, and an amount charged for the advertisement being selected, based on the rate of the billable events.

2. The method of claim 1, wherein said adjusting the pace at which the advertisement is served includes decreasing the pace the advertisement is served.

3. The method of claim 1, wherein the billable events are at least one of serving the advertisement, or the advertisement being selected by an end-user.

4. The method of claim 2, wherein the decreasing the pace the advertisement is served is to prevent charges for the advertisement, within a budget period, from exceeding the budget limit.

5. The method of claim 1, wherein adjusting the rate at which the advertisement is served includes increasing the rate at which the advertisement is served.

6. The method of claim 1, further comprising, in response to reaching the budget limit for an advertisement, performing at least one of ceasing to serve the advertisement, and ceasing to charge for the billable event of the advertisement.

7. The method of claim 1, wherein the adjusting is further based on a time period within a budget period.

8. The method of claim 1, wherein the adjusting is further based on a rate of billable events for the online advertisement in a prior budget period.

9. The method of claim 1, wherein the adjusting the pace includes periodically omitting serving the advertisement when the advertisement is to be served.

10. The method of claim 9, wherein the omitting is performed randomly.

11. The method of claim 9, wherein the omitting is performed in a predetermined sequence.

12. The method of claim 1, wherein the adjusting the pace includes adjusting one or more matching criteria for the advertisement.

13. The method of claim 12, wherein the adjusting the matching criteria includes one of expanding or contracting the matching criteria for the advertisement.

14. The method of claim 1, wherein the adjusting the pace includes adjusting a priority of the advertisement relative to other advertisements.

15. The method of claim 1, wherein the identifying and the adjusting are performed randomly during a budget period.

16. The method of claim 1, wherein the identifying and the adjusting are performed at pre-set time periods during a budget period.

17. The method of claim 16, wherein the identifying and the adjusting are performed at time periods based on at least one of a time period remaining in a budget period, an amount remaining within a budget limit, and the rate of billable events for the online advertisement within at least one of a current budget period or a prior budget period.

18. A system comprising:
A means for identifying a rate of billable events for an online advertisement; and
A means for adjusting at least one of a pace the online advertisement is served, and an amount charged for the advertisement being selected, based on the rate of the billable events.

19. The system of claim 17, wherein said means for adjusting the pace at which the advertisement is served includes means for decreasing the pace the advertisement is served.

20. The system of claim 18, wherein the means for decreasing the pace the advertisement is served is to prevent charges for the advertisement, within a budget period, from exceeding the budget limit.

21. A machine-readable medium having stored thereon a set of instructions, which when executed, perform a method comprising:
identifying a rate of billable events for an online advertisement; and
adjusting at least one of a pace the online advertisement is served, and an amount charged for the advertisement being selected, based on the rate of the billable events.
